(19) United States
(12) Patent Application Publication
(10) Pub. No.: US 2026/0298255 A1
(43) Pub. Date: Oct. 1, 2026

(54) RADIAL COMPRESSOR WITH RADIAL BEARING AND RADIAL SEAL

(71) Applicant: ebm-papst Mulfingen GmbH & Co. KGaA & Co. KG, Mulfingen (DE)

(72) Inventors: Mihai B. Dobrica, Heidelberg (DE); David Klüpfel, Kleinrinderfeld (DE)

(21) Appl. No.: 19/634,815

(22) Filed: Mar. 31, 2026

(30) Foreign Application Priority Data
Apr. 1, 2025 (DE) 10 2025 112 724.7

(51) Int. Cl. F04D 29/057; F04D 17/10; F04D 29/08

(52) U.S. Cl. CPC F04D 29/057; F04D 17/10; F04D 29/083

(57) ABSTRACT

A radial compressor having a housing and a rotor that is rotatable mounted around a rotation axis in the housing via at least one radial bearing and which has a shaft and at least one impeller fixed to the shaft, wherein a hydrodynamic radial seal is provided on the shaft along the rotation axis between the radial bearing and the impeller, which has a static sealing partner and the shaft as a dynamic sealing partner, wherein the radial seal is configured to seal a low-pressure area on the side of the radial bearing against a high-pressure area on the side of the impeller.

### RELATED APPLICATIONS

The present disclosure claims priority to and the benefit of German Application No. 10 2025 112 724.7, filed on Apr. 1, 2025, the entire contents of which is incorporated herein by reference.

### FIELD

The present disclosure relates to a radial compressor having a housing and a rotor that is rotatable mounted around a rotation axis in the housing via at least one radial bearing and which has a shaft and at least one impeller fixed to the shaft. This may be a single-stage radial compressor or a two-stage radial compressor, in particular in an “end-to-end” configuration, in which therefore two impellers are provided which are arranged at opposite end portions of the shaft.

### BACKGROUND

Known in the prior art is a plurality of radial compressors, which can, for example, be used for HVAC (heating, ventilation and air conditioning) applications. Aerodynamic or aerostatic radial bearings are in particular provided for radial mounting in oil-free high-speed centrifugal or radial compressors.

Here, aerodynamic radial bearings themselves generate an air or gas cushion for radial mounting upon corresponding rotatory movement, while in aerostatic radial bearings, on the other hand, air or gas is supplied externally for realization of radial mounting.

The pressure in the area of these radial bearings is low compared to the pressure at the impellers serving for compression of a fluid, so that the radial bearings in the radial compressor or in the housing of the radial compressor are associated with a low-pressure area, while the impeller or the impellers are associated with a high-pressure area.

To separate the low-pressure area in the compressor from the high-pressure area, a seal is preferably provided which is to reduce or prevent a leakage flow from the high-pressure area into the low-pressure area, as otherwise damage to the radial bearings, i.e. bearing damage, and potentially a failure of the radial compressor can occur.

We have discovered a problem with this is, however, that such a seal not only forms an inter-face between the high-pressure side or the high-pressure area and the low-pressure side or the low-pressure area, but simultaneously has to continue to allow the free rotation of the shaft.

Besides, one seal per stage is usually required in multiple-stage compressors.

Typical solutions for this problem are a special sealing element, for example a labyrinth seal, or a seal at the rear side of the impeller, which again may be a labyrinth seal or a step seal.

These typical solutions, however, are comparatively expensive in their manufacture and continue to result in a comparatively high leakage flow, reducing the efficiency of the radial compressor. If the sealed distance is increased for further reduction of the leakage flow, this has a negative effect on the permissible rotational speed of the radial compressor.

It is also possible to use conventional and therefore separately embodied gas seals which, however, require additional assembly steps and, besides, have high requirements regarding their production accuracy and their link to the further components of the radial compressor, so that in practice, the results usually are high expenses for the integration of the seals into the radial compressors and problems regarding the reliability of the radial compressors

### BRIEF SUMMARY

The present disclosure overcomes the disadvantages mentioned above and provides a radial compressor with a seal along the shaft between the high-pressure area and the low-pressure area that is, on the one hand, manufacturable at low costs and, on the other hand, efficient and of compact design.

According to the present disclosure, a radial compressor is proposed having a housing and a rotor that is rotatable mounted around a rotation axis in the housing via at least one radial bearing and which has a shaft and an impeller that is at least connected to the shaft in a rotationally fixed manner and which can also be referred to as a centrifugal compressor. As explained above, this may be either a single-stage, but also a multiple-stage compressor which is preferably embodied as a two-staged radial compressor, in particular in an “end-to-end” configuration. More preferably, the radial compressor is an oil-free compressor which is in particular embodied as a high-speed centrifugal compressor. According to the present disclosure, a hydrodynamic and in particular aerodynamic radial seal is provided on the shaft along the rotation axis between the radial bearing and the impeller, which has a static sealing partner and the shaft as a dynamic sealing partner. Here, the radial seal is configured to reduce and preferably completely prevent a fluid or gas flow from a high-pressure area on the side of or at the impeller to the radial bearing arranged in a low-pressure area, so that the low-pressure area is sealed against the high-pressure area.

To be understood as a hydrodynamic or aerodynamic radial seal is, preferably, a seal which provides its sealing effect through the relative movement of the sealing partners. This way, a gas or air cushion can be generated or generally a pressure generated by the relative movement of the sealing partners can be provided, which reduces or prevents a fluid flow between the sealing partners.

Here, the gas or the fluid is preferably air or another gaseous coolant which is compressed by the radial compressor or conveyed by the impeller.

According to the present disclosure, it is provided that a pressure equalization area is provided between the radial seal and the radial bearing, which is configured to equalize and/or discharge a pressure created by gas entering at the low-pressure area through the radial seal and/or from the high-pressure area. Correspondingly, a or the fluid flow flowing through the radial seal from the high-pressure area in direction of the radial bearing can be equalized or discharged.

If such pressure equalization area is present, the pressure equalization area can be formed by a pressure equalization groove surrounding the rotation axis in a ring shape or a plurality of pressure equalization openings distributed preferably evenly in a circumferential direction around the rotation axis.

It is further provided, according to the present disclosure, that the radial compressor further provides at least one pressure equalization channel that is fluidically connected to the pressure equalization area and which is configured to discharge fluid or a fluid flowing in from the high-pressure area and further in particular an excess pressure created in the pressure equalization area that exceeds the pressure in the low-pressure area away from the pressure equalization area and from the radial bearing into the low-pressure area. It should be mentioned that both the motor and a motor receptacle accommodating the stator of the motor in particular are usually associated with the low-pressure area, wherein the motor receptable can also be referred to as the motor compartment. Correspondingly, it can be provided that the pressure equalization channel is provided and configured to discharge fluid into the motor receptacle and is correspondingly fluidically connected with it. Besides, multiple pressure equalization channels may be provided which are distributed preferably evenly in the circumferential direction.

According to one advantageous development, the radial seal and the radial bearing are each immediately adjacent to the pressure equalization area.

Here, the pressure equalization area can be formed both by the or in the static sealing partner and by the or in the shaft. If the static sealing partner is provided integrally with the static bearing partner, the bushing or sleeve embodying it can also form the pressure equalization area or the groove or openings required for it, which can further also determine the pressure equalization channel or the pressure equalization channels.

It is particularly advantageous if the radial bearing is embodied as a gas lubricated hydrostatic, in particular aerostatic, bearing or as a gas lubricated hydrodynamic, in particular aerodynamic, bearing which has a static bearing partner and a dynamic bearing partner which is formed by the rotor in general or the shaft or by a part fixed to the shaft.

Particularly advantageous in this case is a variant in which the static bearing partner and the static sealing partner are embodied integrally and as one piece. This can be realized in the form of a bushing or sleeve which forms both the static bearing partner and the static sealing partner.

The same also applies to the respective dynamic components, so that is therefore advantageous if the dynamic bearing partner and the dynamic sealing partner are embodied integrally and as one piece and, in particular, are integrated into the shaft or are embodied by the shaft.

A combination of a hydrodynamic or aerodynamic or a hydrostatic or aero-static radial bearing is particularly advantageous because high precision is required for manufacturing such bearings anyway and the combination with a radial seal according to the present disclosure therefore does not cause any significant additional effort.

Further, it is preferably provided that a surface of the shaft, in a portion of the shaft forming the dynamic sealing partner, or generally a surface of the dynamic sealing partner is structured and is thereby configured to reduce gas shear loss and/or leakage flow.

Such structuring or such a structure is, for example, manufacturable through lasering.

For this purpose, such a structure is in particular formed by furrows arranged in a herringbone pattern or by at least one spiral-shaped furrow which is in particular configured to generate a pumping effect in the direction of the high-pressure area.

For clarification, it should be noted that both the dynamic bearing partner and the dynamic sealing partner are formed by the rotor. Preferably, each of these are provided on the shaft or are formed integrally through the shaft. Irrespective of whether the two dynamic partners are each provided by the shaft or as a separate component, for example a cylindrical or ring-shaped insert fixable to the shaft, it is advantageous if the dynamic partners are embodied integrally and as one piece, which can potentially include the pressure equalization area or its pressure equalization groove or pressure equalization opening provided for this purpose.

Preferably, is it provided that the seal clearance of the radial seal is larger than the bearing clearance of the radial bearing, so that the shaft never contacts the static bearing partner and, consequently, the robustness of the radial compressor is increased.

Independent from the proposed radial seal, further seals may be provided for separation of the high-pressure area and the low-pressure area. For example, a static seal can be provided at a diffusor backplate of the compressor, which acts in an axial direction. Further, a static seal can be provided at the diffusor backplate of the compressor, which acts in a radial direction. This realizes a seal at the static components of the compressor and here specifically between the high-pressure side or the high-pressure area, in which for example a diffusor and a spiral housing of the compressor are arranged, towards the low-pressure side or a low-pressure area, wherein the low-pressure area is essentially determined by the motor compartment.

The features disclosed above are combinable as required, provided this is technically possible and they do not contradict one another.

### BRIEF DESCRIPTION OF THE DRAWINGS

Other advantageous developments of the present disclosure are characterized in the dependent claims or represented in greater detail below together with the description of the preferred embodiment of the present disclosure with reference to the figures. In the drawings:

FIG. 1 shows a segment of a longitudinal section of a first variant of a radial compressor;

FIG. 2 shows a segment of a longitudinal section of a second variant of a radial compressor;

FIG. 3 shows a segment of a longitudinal section of a third variant of a radial compressor.

The figures are schematic examples. Same reference numerals in the figures indicate same functional and/or structural features.

### DETAILED DESCRIPTION

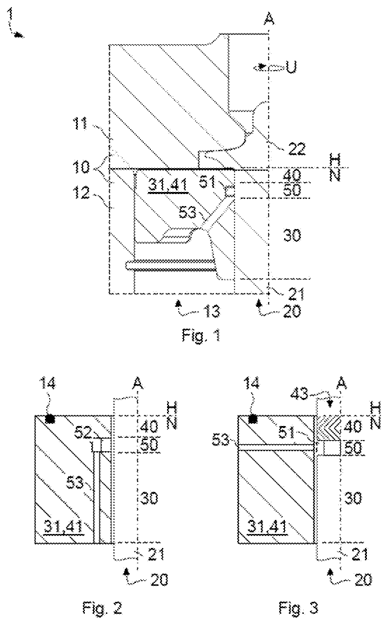

Represented in FIG. 1 is a radial compressor 1 in a longitudinal section along the rotation axis A as well as a segment thereof, so that a housing 10 of the radial compressor 1 with the rotor 20 arranged therein is visible.

Presently, the rotor 20 has a shaft 21 and an impeller 22 provided at the front end thereof, wherein further compressor stages can also be provided. In case of a two-staged radial compressor in an “end-to-end” configuration, for example, a further impeller may be provided on the opposite side of the shaft 21.

Presently, a stator housing portion 12 and a spiral housing portion 11 of the housing 10 are visible, wherein the spiral housing portion 11 corresponds to the impeller 22. Further, the stator housing portion 12 determines a motor compartment 13 for accommodating the electric motor driving the rotor 20 or the shaft 21 and further in particular for accommodating the stator of the electric motor.

The shaft 21 is rotatably mounted in the circumferential direction U around the rotation axis A in the housing 10 and, specifically, in the stator housing portion 12 by means of a radial bearing 30.

Provided as the radial bearing 30 is a gas lubricated hydrodynamic or aerodynamic radial bearing 30, which therefore establishes between its static bearing partner 31 and its dynamic bearing partner a gas or air cush-ion for mounting the shaft 21 upon corresponding movement or, in this case, rotation.

According to the variant shown, the shaft 21 itself is provided and embodied as a dynamic bearing partner.

The basic function of the compressor creates high pressure at and around the impeller 22, which is considerably higher than the pressure in the motor compartment 13 or at the radial bearing 30. Accordingly, the interior of the housing 10 can be split into a high-pressure area H and a low-pressure area N, so that the radial compressor correspondingly has a high-pressure area H and a low-pressure area N.

To prevent leakage from the high-pressure area H into the low-pressure area N, at least one, but usually multiple seals are provided in the radial compressor. These seals can be both static seals that seal individual static components against each other and also seals that are configured to seal components that move relative to one another.

To optimize the sealing along the rotor 20 or the shaft 21, it is provided, according to the present disclosure, that a hydrodynamic or aerodynamic radial seal 40 is provided on the shaft 21 along the rotation axis A between the radial bearing 30 and the impeller 22, which has a static sealing partner 41 and the shaft 21 as a dynamic sealing partner. Upon rotation of the rotor 20 or the dynamic sealing partner, a leakage flow or a fluid flow from the high-pressure area H into the low-pressure area N is reduced or essentially prevented, so that the low-pressure area N on the side of the radial bearing 30 is sealed against the high-pressure area H on the side of the impeller 22.

Essential for both the variants represented in FIG. 1 as well as in FIGS. 2 and 3 is that the static bearing partner 31 of the radial bearing 30 is embodied as one piece and integrally with the static sealing partner 41 of the radial seal 40, wherein these are each embodied as a hollow cylinder-shaped or ring-shaped bushing.

Further, one pressure equalization area 50 each is provided in accordance with the variants represented in FIGS. 1 to 3, wherein the radial seal 40 on the side of the impeller 22 and the radial bearing 30 on the side facing away therefrom are immediately adjacent to or follow the pressure equalization area 50.

On the one hand, the pressure equalization area 50 serves to equalize any leakage flow from the high-pressure area H in the direction of the low-pressure area N in the circumferential direction U that may be present, so that any pressure increase caused by this occurs evenly and not in a one-sided manner. Further, one pressure equalization channel 53 each is provided which allows a fluid flow into the motor compartment 13 or pressure equalization with the motor compartment 13.

Different variants are possible regarding the pressure equalization area 50. For example, it can be embodied by a pressure equalization groove 51 that is formed integrally with the static sealing partner 41 and fully surrounding in the circumferential direction U, as shown in FIG. 1.

Further, a plurality of pressure equalization openings 52 can be provided instead of a surrounding groove 51, which are connected to each other or each have an own pressure equalization channel 53. Such a variant is represented in FIG. 2.

Here, the pressure equalization area 50 does not necessarily have to be provided at the sleeve or bushing forming the static bearing partner 31 and the static sealing partner 41, but can also be embodied at the shaft 21, as is represented in FIG. 3 in form of a pressure equalization groove 51 that fully surrounds the shaft 21 in the circumferential direction U.

In FIG. 3, the radial seal 40 is, in addition, embodied with a structured surface or a structure 43, wherein such structuring is also provided in the further embodiments represented in the figures and which can, for example, also be provided alternatively to the pressure equalization area 50.

The structure 43 creates a “pump out” effect in the direction of the high-pressure area H, so that a leakage flow is reduced further.

Besides, represented in the FIGS. 2 and 3 is a static seal 14 which could also be provided in the variant according to FIG. 1 and is configured to seal the sleeve or bushing forming the static bearing partner 31 and the static sealing partner 41 in the axial direction, i.e. along the rotation axis A, against, for example, the housing 10 or other static components in the high-pressure area H of the compressor 1.

In addition to the represented static seal 14 acting in the axial direction, a static seal, not represented, can also be provided, which seals the sleeve or bushing forming the static bearing partner 31 and the static sealing partner 41 in the radial direction, i.e. orthogonally to the rotation axis A, against, for example, the housing 10 or its stator housing portion 12 or other static components of the compressor 1.

The main advantage of the present disclosure in general and also of all the variants represented in the figures is its low complexity, as preferably a single piece (the sleeve or bushing forming the static bearing partner 31 and the static sealing partner 41) fulfills both the bearing and sealing function, resulting in low manufacturing costs.

Further, a very good dynamic sealing capability is achieved as very narrow gap dimensions can be guaranteed and as the tolerance chain is as short as possible. As a result, the shaft 21 is always perfectly centered in the seal 40 by the radial bearing 30, which minimizes leakage and shear losses.

Besides, the radial seal 40 has a shorter axial length compared to conventional seals as very narrow sealing gaps are achievable, so that the seal 40 can be designed to be very short along the rotation axis A.

A further advantage is the robustness of the radial seal 40 or the compressor 1 manufactured with it, as the shaft 21 never contacts the static bearing partner 41 of the seal 40, provided that the seal clearance is slightly larger than the bearing clearance.

Practice of the present disclosure is not limited to the preferred exemplary embodiments set forth above. Instead, a number of variations may be contemplated which make use of the solution represented even in fundamentally different embodiments.

1. A radial compressor having a housing and a rotor that is rotatably mounted around a rotation axis in the housing via at least one radial bearing and which has a shaft and at least one impeller connected to the shaft,
wherein a hydrodynamic radial seal is provided on the shaft along the rotation axis between the radial bearing and the impeller, which has a static sealing partner and the shaft as a dynamic sealing partner,
wherein the radial seal is configured to reduce and/or to prevent a fluid flow from a high-pressure area on the side of the impeller to the radial bearing arranged in a low-pressure area through gas-dynamic effects and to thereby seal the low-pressure area against the high-pressure area,
wherein a pressure equalization area is provided between the radial seal and the radial bearing, the pressure equalization area being configured to equalize and/or discharge the fluid flow flowing from the high-pressure area through the radial seal in the direction of the radial bearing,
wherein further at least one pressure equalization channel is provided that is fluidically connected to the pressure equalization area and configured to discharge fluid from the pressure equalization area and from the radial bearing into the low-pressure area.

2. The radial compressor according to claim 1,
wherein the pressure equalization area is formed by a pressure equalization groove surrounding the rotation axis in a ring shape or a plurality of pressure equalization openings distributed in a circumferential direction around the rotation axis.

3. The radial compressor according to claim 1,
wherein the radial seal and the radial bearing are each immediately adjacent to the pressure equalization area.

4. The radial compressor according to claim 1,
wherein the pressure equalization area is formed by the static sealing partner and/or by the shaft.

5. The radial compressor according to claim 1,
wherein the radial bearing is embodied as a gas lubricated hydrostatic, in particular aerostatic, or as a gas lubricated hydrodynamic, in particular aerodynamic, bearing which has a static bearing partner and a dynamic bearing partner which is formed by the rotor and, in particular, the shaft.

6. The radial compressor according to claim 5,
wherein the static bearing partner and the static sealing partner are embodied integrally and as one piece.

7. The radial compressor according to claim 1,
wherein a surface of the shaft, in a portion of the shaft forming the dynamic sealing partner, is structured with a structure and is thereby configured to reduce gas shear loss and/or leakage flow.

8. The radial compressor according to claim 7,
wherein the structure is manufacturable through lasering and is formed by furrows arranged in a herringbone pattern or by at least one spiral-shaped furrow, which are configured to generate a pumping effect in the direction of the high-pressure area.
